(19) United States
(12) Patent Application Publication
(10) Pub. No.: US 2020/0299197 A1
(43) Pub. Date: Sep. 24, 2020

(54) METHOD FOR PREPARING DIELECTRIC HAVING LOW DIELECTRIC LOSS AND DIELECTRIC PREPARED THEREBY

(71) Applicant: KOREA ADVANCED INSTITUTE OF SCIENCE AND TECHNOLOGY, Daejeon (KR)

(72) Inventors: Sung-Yoon Chung, Daejeon (KR); Ji-Sang An, Daejeon (KR)

(21) Appl. No.: 16/559,324

(22) Filed: Sep. 3, 2019

(30) Foreign Application Priority Data
Mar. 18, 2019 (KR) 10-2019-0030486

(51) Int. Cl. C04B 35/468; C01G 23/00; C01G 33/00; C04B 35/626; C04B 35/64; H01G 4/12

(52) U.S. Cl. CPC C04B 35/4682; C01G 23/003; C01G 33/00; C04B 35/6262; C04B 35/62675; C04B 2235/85; H01G 4/1218; C04B 2235/3232; C04B 2235/768; C04B 2235/661; C04B 2235/78; C04B 35/64

(57) ABSTRACT

The present disclosure provides a method for preparing a dielectric which can provide a low-dielectric loss dielectric not variable to frequency, wherein the dielectric shows a narrow variation in dielectric characteristics depending on temperature, undergoes no change in dielectric characteristics depending on frequency and thus has a low dielectric loss. The present disclosure also provides a dielectric prepared by the method.

### CROSS-REFERENCE TO RELATED APPLICATION

This application claims priority of Korean Patent Application No. 10-2019-0030486, filed on Mar. 18, 2019, in the KIPO (Korean Intellectual Property Office), the disclosure of which is incorporated herein entirely by reference.

### BACKGROUND OF THE INVENTION

### Field of the Invention

The present disclosure relates to a method for preparing a dielectric having a low dielectric loss and a dielectric prepared thereby.

### Description of the Related Art

A dielectric means a material that causes internal polarization upon the application of an electric field. In general, such a dielectric is used largely as a capacitor that functions to store electricity in order to maintain power source line voltage temporarily or to remove direct current bias voltage in a forward circuit while transferring only alternating current signal voltage to a backward circuit, and is applied frequently to electronic instruments.

In general, according to the standards defined by Electronic Industries Association (EIA), ceramic capacitors may be classified into Class I and Class II depending on dielectric materials. Class I is for use in temperature compensation, has a low dielectric constant and a low dielectric loss, frequently shows a small variation in capacity depending on temperature and voltage, and exhibits stability to a specific level of frequency. Class II shows a large variation in capacity depending on temperature and voltage and has a high dielectric loss, but is characterized by a high dielectric constant.

Recently, as electronic instruments have been significantly downsized, weight-lightened and integrated, compact capacitors have been in increasingly in demand to improve mounting density and a dielectric based on barium titanate having a high dielectric constant has been studied to meet such demand. However, barium titanate itself shows a high variation in capacity depending on temperature, has a relatively high dielectric loss and exhibits low dielectric constant stability against frequency due to an alleviation effect depending on frequency.

In general, some studies have been conducted to reduce a change in dielectric constant depending on temperature, and such studies include incorporation of oxide-based additives other than barium titanate, formation of a core-shell structure through preliminary grain coating in the initial grain formation step, or connection of an organic polymer material to barium titanate grains.

When an electric field is applied to a dielectric, it causes arrangement of dipole moments to the alternating current frequency. Herein, it can be stated that an efficient dielectric is a dielectric which minimizes loss of energy in the form of heat and allows electric field energy to contribute to dipole arrangement. For this purpose, it is required that a dielectric having a dielectric loss as low as possible to show high efficiency.

A dielectric shows a wide range of variation in dielectric constant depending on frequency due to a dielectric alleviation effect. In some technologies and electronic instruments requiring stable dielectric characteristics even in a high frequency region, there has been a need for a dielectric showing constant dielectric constant characteristics regardless of frequency in order to meet such requirement.

### SUMMARY OF THE INVENTION

A technical problem to be solved by the present disclosure is to provide a method for preparing a dielectric which can provide a dielectric having a low dielectric loss.

More particularly, a technical problem to be solved by the present disclosure is to provide a method for preparing a dielectric which can provide a low-dielectric loss dielectric not variable to frequency, wherein the dielectric shows a narrow variation in dielectric characteristics depending on temperature, undergoes no change in dielectric characteristics depending on frequency and thus has a low dielectric loss.

Another technical problem to be solved by the present disclosure is to provide a dielectric prepared by the method.

In one general aspect, there is provided a method for preparing a dielectric, including the steps of: preparing ABO₃ oxide having a melting point lower than the firing temperature of barium titanate (BaTiO₃); mixing barium titanate with ABO₃ oxide to obtain a mixture satisfying the following Formula 1; and sintering the mixture at a temperature equal to or higher than the melting point of ABO₃ oxide, wherein the ABO₃ oxide is introduced to and distributed in the grain boundary of barium titanate in the sintering step:

(1−x)BaTiO₃—xABO₃ [Formula 1]
wherein x is 0.01−0.30.

In another general aspect, there is provided a dielectric which includes barium titanate (BaTiO₃) and ABO₃ oxide to satisfy the following Formula 1, wherein the ABO₃ oxide is amorphously distributed in the grain boundary of barium titanate:

(1−x)BaTiO₃—xABO₃ [Formula 1]
wherein x is 0.01−0.30.

The dielectric prepared by the method for preparing a dielectric according to the embodiments of the present disclosure is obtained by mixing barium titanate with ABO₃ oxide having a melting point lower than the firing temperature of barium titanate, shows a high specific inductive capacity and low dielectric loss, and has a low variation in dielectric constant depending on a change in temperature.

In addition, in the case of room-temperature resistivity, the dielectric shows a resistivity from 1E11 Ohm-cm up to 1E13 ohm-cm or more, and can characteristically show TCC±15% to 135-140° C. in a high-temperature region.

Further, the dielectric according to the embodiments of the present disclosure has a high dielectric resistivity and excellent temperature stability, and thus can be applied to passive elements of IT products requiring high temperature stability.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a diagram showing the structure of a node including a regulating scheduler and flow aggregates in the node according to an embodiment of the present disclosure.

FIGS. 1 and 2 are flow charts illustrating the method for preparing a dielectric according to an embodiment of the present disclosure.

FIG. 3 shows scanning electron microscopic images illustrating the grain sizes of barium titanate and ABO₃ oxide powder according to the embodiments of the present disclosure ((a) BaTiO₃, (b) K_{0.5}Na_{0.5}NbO₃, (c) KNb_{0.5}Ta_{0.5}O₃, (d) AgNb_{0.5}Ta_{0.5}O₃).

FIG. 4 is a schematic view illustrating the microstructure of the dielectric obtained according to an embodiment of the present disclosure.

FIG. 5 shows scanning electron microscopic images illustrating the microstructures of fired specimens depending on ABO₃ oxide type in 90BaTiO₃−10ABO₃+1 wt % SiO₂ according to an embodiment of the present disclosure ((a) 90BaTiO₃+10KNN+1 wt % SiO₂, (b) 90BaTiO₃+10KNT+1 wt % SiO₂, (c) 90BaTiO₃+10ANT+1 wt % SiO₂).

FIGS. 6 to 8 each show images obtained by using energy dispersive spectroscopy (EDS) mapping through a transmission electron microscope, and illustrating the distribution of corresponding elements for the specimens of 90BaTiO₃−10KNN+1 wt % SiO₂, 90BaTiO₃−10KNT+1 wt % SiO₂ and 90BaTiO₃−10ANT+1 wt % SiO₂.

FIG. 9 is a graph illustrating variations in specific inductive capacity and dielectric loss values depending on frequency, determined as a function of concentration of x in the specimen of (100−x)BaTiO₃−xKNN+1 wt % SiO₂ according to an embodiment of the present disclosure.

FIG. 10 is a graph illustrating variations in specific inductive capacity and dielectric loss values depending on SiO₂ content in 90BaTiO₃−10KNN according to an embodiment of the present disclosure, wherein the values below the graphs are tables representing the room-temperature resistivity of each specimen.

FIG. 11 is a graph illustrating variations in specific inductive capacity and dielectric loss values depending on frequency, determined as a function of concentration of x in the specimen of (100−x)BaTiO₃−xKNT+1 wt % SiO₂ according to an embodiment of the present disclosure.

FIG. 12 is a graph illustrating variations in specific inductive capacity and dielectric loss values depending on SiO₂ content in 90BaTiO₃−10KNT according to an embodiment of the present disclosure.

FIG. 13 is a graph illustrating variations in specific inductive capacity and dielectric loss values depending on frequency, determined as a function of concentration of x in the specimen of (100−x)BaTiO₃−xANT+1 wt % SiO₂ according to an embodiment of the present disclosure.

FIG. 14 is a graph illustrating variations in specific inductive capacity and dielectric loss values depending on SiO₂ content in 90BaTiO₃−10ANT according to an embodiment of the present disclosure.

FIG. 15 is a graph illustrating variations in specific inductive capacity and dielectric loss values as a function of temperature depending on ABO₃ oxide type in 90BaTiO₃−10ABO₃+1 wt % SiO₂ according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

In one aspect, there are provided a method for preparing a dielectric having a low dielectric loss, and a dielectric prepared thereby.

Particularly, the dielectric according to the embodiments of the present disclosure is obtained by mixing barium titanate with ABO₃ oxide having a melting point lower than the firing temperature of barium titanate, shows a high specific inductive capacity and low dielectric loss, and has a low variation in dielectric constant depending on a change in temperature. In addition, in the case of room-temperature resistivity, the dielectric shows a resistivity from 1E11 Ohm-cm up to 1E13 ohm-cm or more, and can characteristically show TCC±15% to 135-140° C. in a high-temperature region.

Further, the dielectric according to the embodiments of the present disclosure has a high dielectric resistivity and excellent temperature stability, and thus can be advantageously applied to passive elements of IT products requiring high temperature stability.

Hereinafter, the present disclosure will be explained in detail.

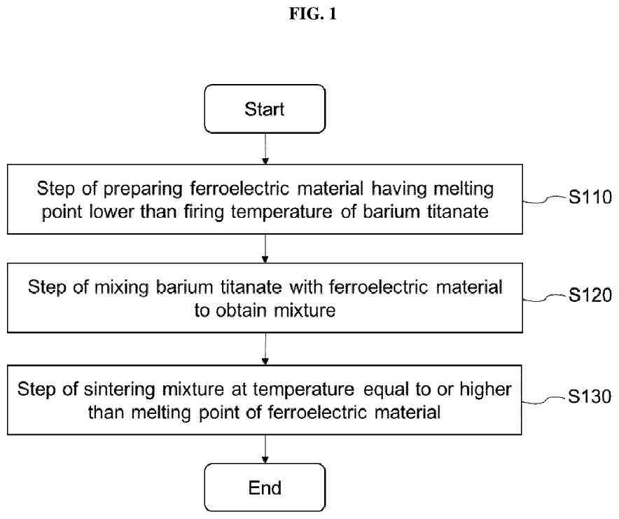

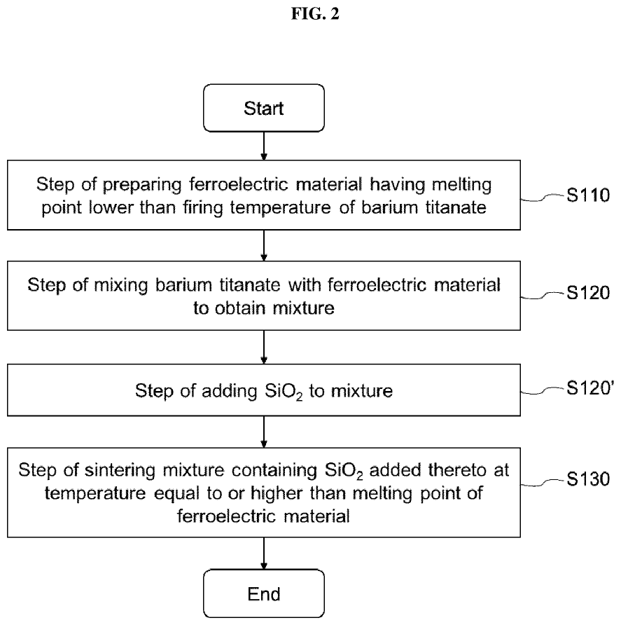

FIGS. 1 and 2 are flow charts illustrating the method for preparing a dielectric according to an embodiment of the present disclosure. The method for preparing a dielectric according to the present disclosure will be explained in detail with reference to FIGS. 1 and 2.

The method for preparing dielectric includes the steps of: (S110) preparing ABO₃ oxide having a melting point lower than the firing temperature of barium titanate (BaTiO₃); (S120) mixing barium titanate with ABO₃ oxide to obtain a mixture satisfying the following Formula 1; and (S130) sintering the mixture at a temperature equal to or higher than the melting point of ABO₃ oxide, wherein the ABO₃ oxide is introduced to and distributed in the grain boundary of barium titanate in the sintering step:

(1−x)BaTiO₃—xABO₃ [Formula 1]

wherein x is 0.01−0.30.

First, step (S110) will be explained. This is a step of preparing ABO₃ oxide having a melting point lower than the firing temperature of barium titanate (powder). ABO₃ oxide means an oxide having a structure of ABO₃ and has a perovskite structure having a molecular formula of ABO₃ in a particular embodiment. For example, ABO₃ oxide may mean a ferroelectric material. To obtain ABO₃ oxide, raw material powder corresponding to each of A and B is weighed at an adequate ratio, subjected to wet milling, drying, pulverization and sieving, and then calcined to finish synthesis. Herein, the melting point of ABO₃ oxide should be lower than the firing temperature of barium titanate.

Particularly, a molecular formula of AₐB_{b}O₃ may be derived from ABO₃ oxide, wherein A may be at least one element selected from the group consisting of lithium (Li), potassium (K), sodium (Na) and silver (Ag), and B may be at least one element selected from the group consisting of vanadium (V), niobium (Nb) and tantalum (Ta). In addition, a may be 0.1-1, and b may be 0.1-1.

More particularly, a molecular formula of AₐA′₍₁₋ₐ₎B_{b}B′_{(1-b)}O₃ may be derived from ABO₃ oxide, wherein each of A and A′ may be at least one element selected from the group consisting of lithium (Li), potassium (K), sodium (Na) and silver (Ag), and each of B and B′ may be at least one element selected from the group consisting of vanadium (V), niobium (Nb) and tantalum (Ta). In addition, a may be 0.1-1, and b may be 0.1-1.

The ABO₃ oxide means an oxide having a structure of ABO₃, and may be a ferroelectric material, for example. A ferroelectric material means a crystal having spontaneous electric polarization and the spontaneous polarization can be reversed in direction by an electric field. For example, the ferroelectric material may be at least one selected from the group consisting of K_{0.5}Na_{0.5}NbO₃, KNb_{0.5}Ta_{0.5}O₃ and AgNb_{0.5}Ta_{0.5}O₃, and may be K_{0.5}Na_{0.5}NbO₃, KNb_{0.5}Ta_{0.5}O₃ or AgNb_{0.5}Ta_{0.5}O₃.

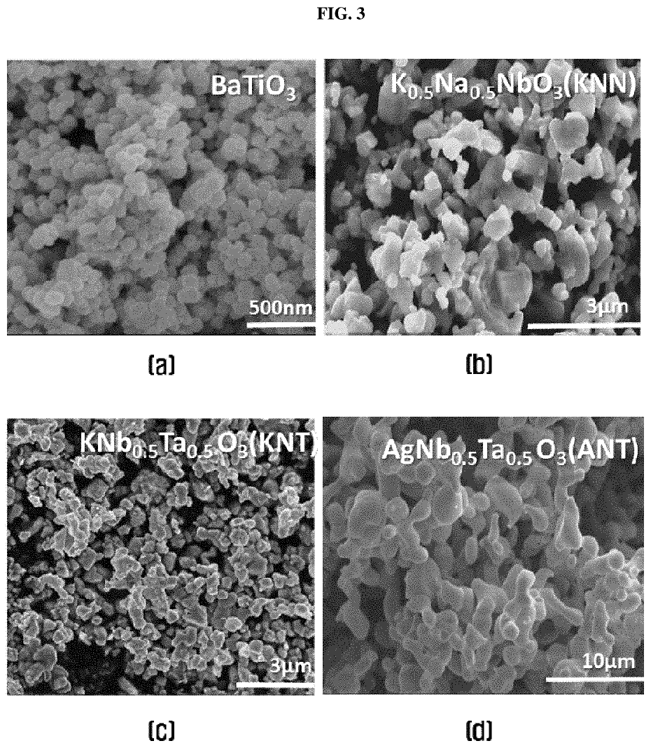

FIG. 3 shows scanning electron microscopic images illustrating the grain sizes of barium titanate and ABO₃ oxide powder according to the embodiments of the present disclosure ((a) BaTiO₃, (b) K_{0.5}Na_{0.5}NbO₃, (c) KNb_{0.5}Ta_{0.5}O₃, (d) AgNb_{0.5}Ta_{0.5}O₃).

Particularly, each of K_{0.5}Na_{0.5}NbO₃, KNb_{0.5}Ta_{0.5}O₃ and AgNb_{0.5}Ta_{0.5}O₃ used as ABO₃ oxide 200 according to an embodiment of the present disclosure may be obtained by calcination of raw material powder, such as K₂CO₃, Na₂CO₃ and Nb₂O₅, K₂CO₃, Nb₂O₅ and Ta₂O₅, and Ag₂CO₃, Nb₂O₅ and Ta₂O₅, through a solid phase synthesis process. Hereinafter, K_{0.5}Na_{0.5}NbO₃, KNb_{0.5}Ta_{0.5}O₃ and AgNb_{0.5}Ta_{0.5}O₃ are expressed as KNN, KNT and ANT, respectively.

For example, in the case of K_{0.5}Na_{0.5}NbO₃ (KNN) mixed powder, it may be obtained by calcination at a temperature of 850-1000° C. In addition, in the case of KNb_{0.5}Ta_{0.5}O₃ (KNT) mixed powder, it may be obtained by calcination at a temperature of 850-950° C. Further, in the case of AgNb_{0.5}Ta0.5O₃ (ANT) mixed powder, its preparation may be carried out at a temperature of 900-1000° C.

Step (S120) is a step of preparing a mixture by mixing barium titanate with ABO₃ oxide.

Herein, the mixture is characterized in that is satisfies the following Formula 1:

(1−x)BaTiO₃—xABO₃ [Formula 1]

wherein x is 0.01−0.30.

Particularly, x in Formula 1 represents the molar ratio of ABO₃ oxide, wherein x may be 0.01-0.30, 0.03-0.20, or 0.05-0.15.

In a particular embodiment, when x is less than 0.05, the amount of ABO₃ oxide is relatively much smaller than the amount of barium titanate and is insufficient to be introduced homogeneously to the grain boundary. Thus, the dielectric constant may be varied depending on frequency. In addition, the dielectric may show a large value of dielectric loss. On the other hand, when x is larger than 0.15, ABO₃ oxide may not be distributed in the grain boundary during calcination but may be introduced into crystallites to form a solid solution, which may result in a significantly low value of dielectric constant. Therefore, it is preferred that x is 0.05-0.15.

More particularly, the mixture satisfies the following Formula 2:

(1−x)BaTiO₃—xAaBbO₃ [Formula 2]

wherein A is at least one selected from the group consisting of lithium (Li), potassium (K), sodium (Na) and silver (Ag),

B is at least one selected from the group consisting of vanadium (V), niobium (Nb) and tantalum (Ta),

x is 0.05-0.15,

a is 0.1-1, and

b is 0.1-1.

In the step of preparing a mixture, barium titanate and ABO₃ oxide are allowed to be distributed in each other upon mixing of the mixture so that ABO₃ oxide may infiltrate to the grain boundary of barium titanate in a liquid phase at a temperature equal to or higher than the melting point during the preparation of a dielectric to form a grain boundary.

Meanwhile, step (S120) of preparing a mixture may further include step (S120′) of adding SiO₂ to the mixture of barium titanate with ABO₃ oxide.

More particularly, the content of SiO₂ added to the mixture may be 20 wt % or less, 10 wt % or less, 5 wt % or less, or 3 wt % or less based on the weight of barium titanate. In a particular embodiment, the content of SiO₂ may be 0.5-2 wt % based on the total weight of the dielectric. The addition ratio of SiO₂ may not be based on the weight of the total mixture but may be based on the weight of barium titanate to be mixed.

In a particular embodiment, when the content of SiO₂ is larger than 10 wt % based on the total weight of barium titanate, the dielectric constant may be reduced abnormally. When the content of SiO₂ is less than 0.5 parts by weight, sintering property may be degraded. In addition, since SiO₂ functions to reduce the sintering temperature, it may serve to accelerate sintering in the subsequent sintering step.

Step (S130) is a step of sintering the mixture or the mixture containing SiO₂ added thereto at a temperature equal to or higher than the melting point of ABO₃ oxide 200. When carrying out sintering at a temperature equal to or higher than the melting point of ABO₃ oxide 200, ABO₃ oxide 200 is molten so that it may be distributed uniformly between grains of barium titanate 100 in a liquefied state. The sintering temperature is preferably about 70-90% of the melting point of barium titanate 100, but is not limited thereto. More particularly, as the sintering temperature passes the melting point of ABO₃ oxide 200, ABO₃ oxide 200 undergoes a change in phase from a solid phase to a liquid phase and is introduced to the grain boundary. Herein, grain growth and densification of barium titanate 100 occur actively, while liquid-sate ABO₃ oxide 200 may be introduced to and distributed in the grain boundary. Thus, in the dielectric according to the present disclosure, ABO₃ oxide 200 may be amorphously distributed in the grain boundary of barium titanate 100.

The sintering step may be carried out under N₂ atmosphere, and particularly under oxygen-free atmosphere. Particularly, the sintering step may be carried out at a temperature of 900-1300° C., 1100-1300° C., or 1200-1300° C. Preferably, the sintering temperature is suitably 1200-1300° C. When the sintering temperature is lower than the above-defined range, firing of a dielectric specimen is carried out incompletely to cause significant degradation of dielectric properties and dielectric resistance. For example, the sintering step may be carried out by heat treatment under N₂ atmosphere and ambient pressure at an average temperature of 1250° C. for 1 hour.

In another aspect, there is provided a dielectric which includes barium titanate (BaTiO₃) and ABO₃ oxide to satisfy the following Formula 1, wherein the ABO₃ oxide is amorphously distributed in the grain boundary of barium titanate:

(1−x)BaTiO₃—xABO₃ [Formula 1]

wherein x is 0.01-0.30

Particularly, x in Formula 1 represents the molar ratio of ABO₃ oxide, wherein x may be 0.01-0.30, 0.03-0.20, or 0.05-0.15.

Particularly, A of ABO₃ oxide in Formula 1 may be an element with a valence of 1+, and B may be an element with a valence of 5+. The dielectric according to the present disclosure may be converted into a solid phase by adding ABO₃ oxide having a lower melting point, heat treating the mixture at a temperature equal to or higher than the melting point of ABO₃ oxide, and reducing the temperature to room temperature. The added ABO₃ oxide is introduced to the grain boundary of barium titanate to provide an excellent dielectric resistivity and a low dielectric loss, to allow maintenance of a constant value of specific inductive capacity and to show high temperature stability.

More particularly, barium titanate (BaTiO₃) and ABO₃ oxide in the dielectric may satisfy the following Formula 2:

(1−x)BaTiO₃—xAaBbO₃ [Formula 2]

wherein A is at least one selected from the group consisting of lithium (Li), potassium (K), sodium (Na) and silver (Ag),

B is at least one selected from the group consisting of vanadium (V), niobium (Nb) and tantalum (Ta),

x is 0.05-0.15,

a is 0.1-1, and

b is 0.1-1.

For example, the ABO₃ oxide may be K_{0.5}Na_{0.5}NbO₃, KNb_{0.5}Ta_{0.503} or AgNb_{0.5}Ta_{0.5}O₃.

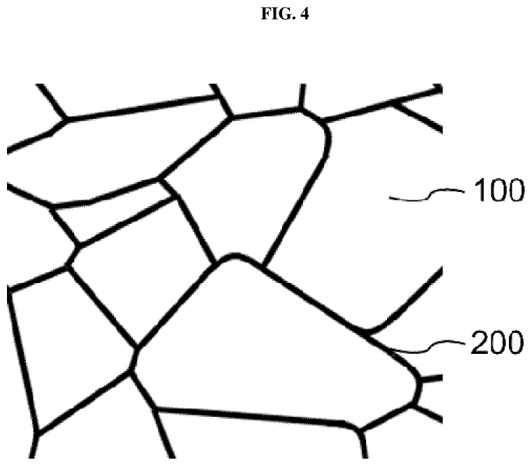

FIG. 4 is a schematic view illustrating the microstructure of the dielectric obtained according to an embodiment of the present disclosure. Referring to FIG. 4, it can be seen that ABO₃ oxide is amorphously distributed in the grain boundary of barium titanate.

Herein, ‘amorphous’ refers to a material having no clear form or structure. In other words, in the dielectric, ABO₃ oxide may be dispersed randomly in the barium titanate grain boundary.

The dielectric maintains a dielectric loss value of 0-3% regardless of frequency regions and a variation of specific inductivity capacity may be maintained at 20% or less.

According to an embodiment of the present disclosure, ABO₃ oxide may be K_{0.5}Na_{0.5}NbO₃, and the dielectric may have a specific inductive capacity of 500-1400 in a frequency region of 1 MHz or more.

According to an embodiment of the present disclosure, ABO₃ oxide may be KNb_{0.5}Ta_{0.5}O₃, and the dielectric may have a specific inductive capacity of 400-1100 in a frequency region of 1 MHz or more.

According to an embodiment of the present disclosure, ABO₃ oxide may be AgNb_{0.5}Ta_{0.5}O₃, and the dielectric may have a specific inductive capacity of 600-1200 in a frequency region of 1 MHz or more.

In addition, the dielectric may have an average grain size of 0.1-1 μm.

The dielectric can maintain a value of room-temperature specific inductive capacity ±15% at a temperature ranging from room temperature to 135° C. or higher. In the case of a dielectric loss, the dielectric can maintain a value of 1% or less at a temperature ranging from room temperature to 200° C. or higher.

Exemplary embodiments and experiments now will be described more fully hereinafter.

However, the exemplary embodiments and experiments are for illustrative purposes only, and the present disclosure should not be construed as limited to the exemplary embodiments and experiments set forth therein.

### EXAMPLES

### Example 1. Preparation of BaTiO₃-KNN Dielectric Synthesis of K_{0.5}Na_{0.5}NbO₃ (KNN)

The starting materials used for synthesizing K_{0.5}Na_{0.5}NbO₃ (KNN) are K₂CO_{3,} Na₂CO₃ and Nb₂O₅. Powder of each starting material was weighed according to a predetermined ratio and subjected to wet milling for 24 hours by using zirconia balls as mixing and dispersion media and high-purity ethanol as a solvent.

After completion of ball milling, the solution of mixed powder of starting materials was dried on a hot plate to obtain a slurry state. The resultant slurry was dried completely by using an oven at 80° C. or higher.

Then, the dried powder was pulverized by using an agate mortar and sieved by using a sieve with a size of 75 μm.

After completion of sieving, the mixed powder of K_{0.5}Na_{0.5}NbO₃ (KNN) starting materials was calcined by using a box-shaped electric furnace at 1000° C. for 10 hours. The resultant K_{0.5}Na_{0.5}NbO₃ (KNN) is shown in FIG. 3(b).

Preparation of BaTiO₃-KNN

A dielectric having a composition of (100−x)BaTiO₃−xKNN+ywt % SiO₂ (wherein 5≤x≤15, 0.5≤y≤2) was prepared.

Barium titanate (BaTiO₃) as a main ingredient was provided in the form of powder having an average size of 100 nm (FIG. 3(a)).

Barium titanate powder was mixed with K_{0.5}Na_{0.5}NbO₃ (KNN) powder, and SiO₂ was added to the mixed powder. Meanwhile, since SiO₂ reduces sintering temperature, it may be used for acceleration of sintering.

The following Table 1 shows the molar ratio of K_{0.5}Na_{0.5}NbO₃ (KNN) and SiO₂ in each Example.

TABLE 1

| | (100-x)BaTiO₃-xKNN | | Additive based on BaTiO₃ |
|---|---|---|---|
| | BaTiO₃ | KNN | SiO₂ |
| | (100-x) | (x) | (wt %) |
| Example 1-1 | 95 | 5 | 0.5 |
| Example 1-2 | 95 | 5 | 1 |
| Example 1-3 | 95 | 5 | 2 |
| Example 1-4 | 90 | 10 | 0.5 |
| Example 1-5 | 90 | 10 | 1 |
| Example 1-6 | 90 | 10 | 2 |
| Example 1-7 | 85 | 15 | 0.5 |
| Example 1-8 | 85 | 15 | 1 |
| Example 1-9 | 85 | 15 | 2 |

The mixed powder was subjected to wet milling for 24 hours by using zirconia balls as mixing and dispersion media and high-purity ethanol as a solvent. Then, drying, pulverization and sieving were carried out in the same manner as preparation of K_{0.5}Na_{0.5}NbO₃ (KNN).

Next, the mixed powder was molded under pressure by using a metal mold having a diameter of 10 mm to manufacture a disc-shaped pellet sample. Then, cold isobaric compression was carried out under a pressure of 200 Mpa for 10 minutes. It is possible to increase the density of a dielectric sample through the isobaric compression at high pressure before sintering.

After that, the sample molded in the shape of a disc was fired by using a vertical heating furnace under nitrogen atmosphere at a temperature of about 1250° C. for about 2 hours to obtain a dielectric (BaTiO₃-KNN).

### Example 2. Preparation of BaTiO₃-KNT Dielectric Synthesis of KNb_{0.5}Ta_{0.5}O₃ (KNT)

The starting materials used for synthesizing KNb_{0.5}Ta_{0.5}O₃ (KNT) are K₂CO₃, Nb₂O₅ and Ta₂O₅. Powder of each starting material was weighed according to a predetermined ratio and subjected to wet milling for 24 hours by using zirconia balls as mixing and dispersion media and high-purity ethanol as a solvent.

Then, drying and sieving were carried out in the same manner as Example 1.

After completion of sieving, the mixed powder of KNb_{0.5}Ta_{0.5}O₃ (KNT) starting materials was calcined by using a box-shaped electric furnace at 950° C. for 12 hours.

The resultant KNb_{0.5}Ta_{0.5}O₃ (KNT) is shown in FIG. 3(c).

### Preparation of BaTiO₃-KNT

A dielectric having a composition of (100−x)BaTiO₃−xKNT+ywt % SiO₂ (wherein 5≤x≤15, 0.5≤y≤2) was prepared.

Barium titanate (BaTiO₃) as a main ingredient was provided in the form of powder having an average size of 100 nm according to a preferred size of several hundreds of nanometers.

A dielectric (BaTiO₃-KNT) was obtained in the same manner as Example 1, except that barium titanate powder was mixed with KNb_{0.5}Ta_{0.5}O₃ (KNT) powder.

The following Table 2 shows the molar ratio of KNT and SiO₂ in each Example.

TABLE 2

| | (100-x)BaTiO₃-xKNT | | Additive based on BaTiO₃ |
|---|---|---|---|
| | BaTiO₃ | KNT | SiO₂ |
| | (100-x) | (x) | (wt %) |
| Example 2-1 | 95 | 5 | 0.5 |
| Example 2-2 | 95 | 5 | 1 |
| Example 2-3 | 95 | 5 | 2 |
| Example 2-4 | 90 | 10 | 0.5 |
| Example 2-5 | 90 | 10 | 1 |
| Example 2-6 | 90 | 10 | 2 |
| Example 2-7 | 85 | 15 | 0.5 |
| Example 2-8 | 85 | 15 | 1 |
| Example 2-9 | 85 | 15 | 2 |

### Example 3. Preparation of BaTiO₃-xANT

### Synthesis of AgNb_{0.5}Ta_{0.5}O₃ (ANT)

The starting materials used for synthesizing AgNb_{0.5}Ta_{0.5}O₃ (ANT) are Ag₂CO₃, Nb₂O₅ and Ta₂O₅. First, Nb₂O₅ and Ta₂O₅ of the powder of starting materials were mixed preliminarily in order to prevent deposition of Ag caused by reduction, and heat treatment was carried out in the air at 1200° C. for 12 hours. Next, powder of the starting material of Ag was weighed and mixed with the heat-treated powder, and then the resultant mixture was subjected to wet milling for 24 hours by using zirconia balls as mixing and dispersion media and high-purity ethanol as a solvent.

Then, drying and sieving were carried out in the same manner as Example 1.

After completion of sieving, the mixed powder of AgNb_{0.5}Ta_{0.5}O₃ (ANT) starting materials was calcined by using a vertical heating furnace at 970° C. for 10 hours.

The resultant AgNb_{0.5}Ta_{0.5}O₃ (ANT) is shown in FIG. 3(d).

### Preparation of BaTiO₃-ANT

A dielectric having a composition of (100−x)BaTiO₃−xANT+ywt %SiO₂ (wherein 5≤x≤15, 0.5≤y≤2) was prepared.

A dielectric (BaTiO₃-ANT) was obtained in the same manner as Example 1, except that barium titanate powder was mixed with AgNb_{0.5}Ta_{0.5}O₃ (ANT) powder.

The following Table 3 shows the molar ratio of ANT and SiO₂ in each Example.

TABLE 3

| | (100-x)BaTiO₃-xANT | | Additive based on BaTiO₃ |
|---|---|---|---|
| | BaTiO₃ | ANT | SiO₂ |
| | (100-x) | (x) | (wt %) |
| Example 3-1 | 95 | 5 | 0.5 |
| Example 3-2 | 95 | 5 | 1 |
| Example 3-3 | 95 | 5 | 2 |
| Example 3-4 | 90 | 10 | 0.5 |
| Example 3-5 | 90 | 10 | 1 |
| Example 3-6 | 90 | 10 | 2 |
| Example 3-7 | 85 | 15 | 0.5 |
| Example 3-8 | 85 | 15 | 1 |
| Example 3-9 | 85 | 15 | 2 |

### TEST EXAMPLES

### Test Example 1. Observation of Surface of Dielectric

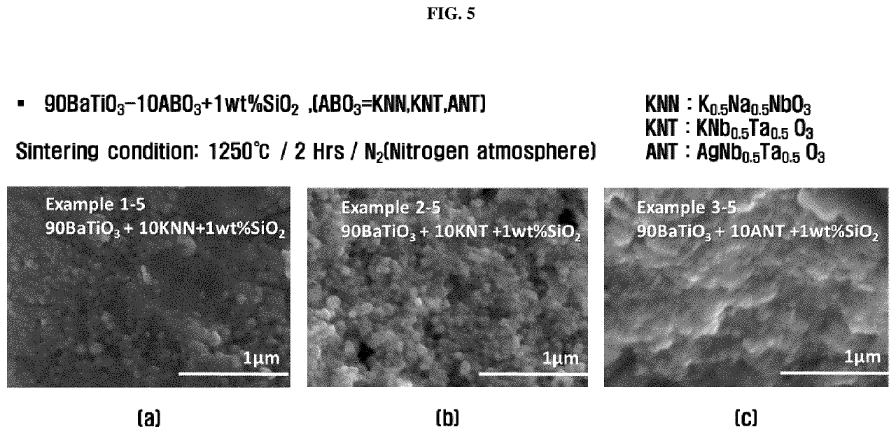

The microstructure of each of the dielectrics obtained from Examples was determined through a scanning electron microscope. Particularly, fired specimens of 90BaTiO₃-10ABO₃+1 wt % SiO₂ according to Examples 1-5, 2-5 and 3-5 were determined through a scanning electron microscope (SEM). The SEM images are shown in FIG. 5.

FIG. 5 shows scanning electron microscopic images illustrating the microstructures of fired specimens depending on ABO₃ oxide type in 90BaTiO₃-10ABO₃+1 wt % SiO₂ according to an embodiment of the present disclosure ((a) 90BaTiO₃+10KNN+1 wt % SiO₂, (b) 90BaTiO₃+10KNT+1 wt % SiO₂, (c) 90BaTiO₃+10ANT+1 wt % SiO₂).

Herein, ABO₃ represents K0.5Na0.5NbO3, KNb0.5Ta0.5O3 or AgNb0.5Ta0.5O3. Meanwhile, the corresponding bulk samples were heat treated at 1250° C. under nitrogen atmosphere for 2 hours.

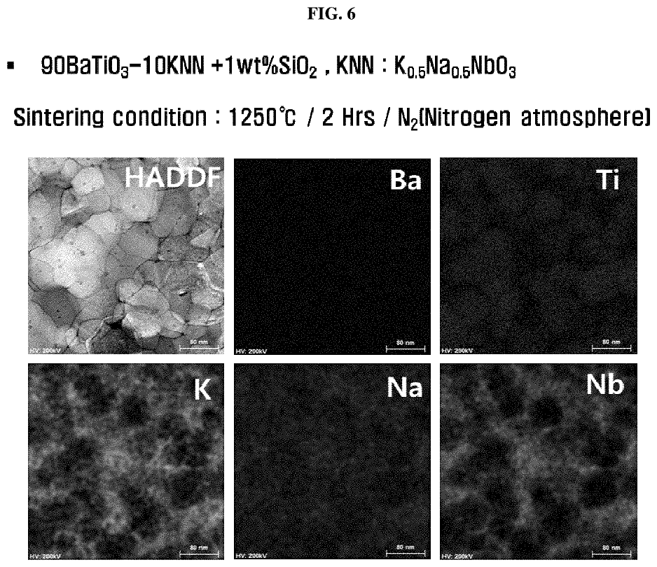

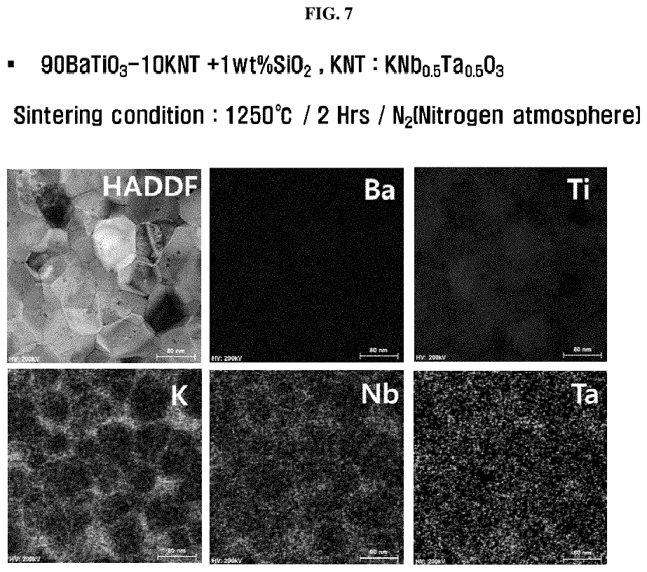

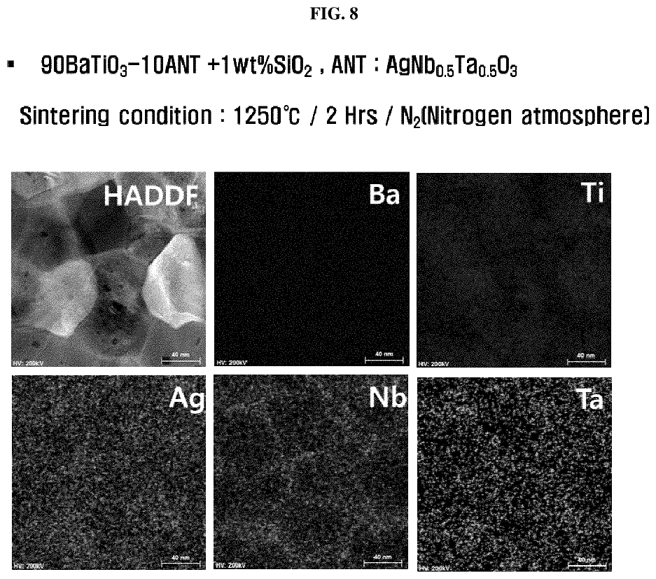

In addition, the specimens were observed through a transmission electron microscope and the results are subjected to energy dispersive spectroscopy (EDS) mapping. The results are shown in FIGS. 6 to 8.

FIGS. 6 to 8 each show images obtained by using EDS mapping through a transmission electron microscope, and illustrating the distribution of corresponding elements for the specimens of 90BaTiO₃-10KNN+1 wt % SiO₂, 90BaTiO₃-10KNT+1 wt % SiO₂ and 90BaTiO₃-10ANT+1 wt % SiO₂.

The specimens using different types of ABO₃ oxide shows no significant difference as compared to the grain size of pure barium titanate, suggesting that densification is accomplished without grain growth.

After checking the EDS mapping images, it can be seen that ABO₃ oxide is introduced to the crystal grains and grain boundary of barium titanate grains. It is thought that as the heat treatment temperature passes from a temperature equal to or lower than the melting point of barium titanate to a temperature equal to or higher than the melting point of ABO₃ oxide, ABO₃ oxide is molten from a solid phase to a liquid phase and is introduced to the grain boundary, while densification of barium titanate grains occurs.

Then, when the temperature is reduced after the completion of heat treatment, the temperature becomes equal to or lower than the melting point of ABO₃ oxide, and ABO₃ oxide present in the grain boundary in a liquid phase is converted into a solid phase and is positioned at the corresponding site.

It can be seen from the EDS mapping images that the corresponding elements of ABO₃ oxide are not infiltrated to the grain boundary occasionally but form crystal grains per se. It is thought that such crystal grains are formed by powder of ABO₃ oxide having a relatively large grain size.

### Test Example 2. Analysis of Dielectric Characteristics and Room-Temperature Resistivity Analysis of Dielectric Characteristics and Room-Temperature Resistivity of Example 1

Both surfaces of disc-shaped pellets obtained by the method according to Example 1 were polished and Ag paste was applied to both surfaces of a specimen through a silk-screening process. Then, heat treatment was carried out at a temperature of about 700° C. for about 30 minutes.

After applying electrodes to both surfaces as mentioned above, an LCR meter was used to measure a dielectric constant and dielectric loss while applying an alternating current frequency ranging from 100 Hz to 2 MHz, and a high-resistance measuring instrument was used to determine dielectric resistance by applying a direct current voltage of 250 V.

More particularly, the specimen including electrodes applied to both surfaces thereof as mentioned above was determined for its dielectric constant and dielectric loss as a function of temperature at a temperature ranging from room temperature to 200° C. at an interval of 10° C. Herein, the dielectric characteristics were measured as values corresponding to a frequency of 1 kHz.

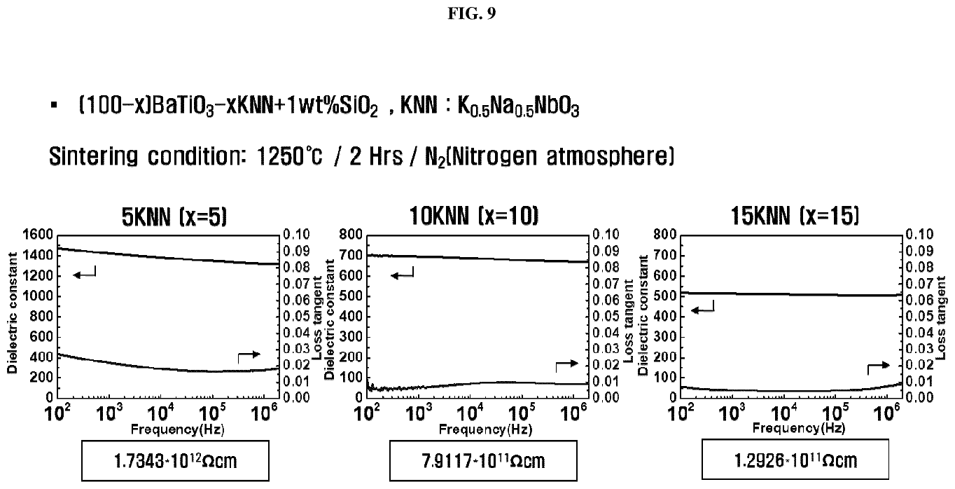

The results are shown in FIG. 9. FIG. 9 is a graph illustrating variations in specific inductive capacity and dielectric loss values depending on frequency, determined as a function of concentration of x in the specimen of (100−x)BaTiO₃−xKNN+1 wt % SiO₂ according to an embodiment of the present disclosure, wherein the values below the graphs are tables representing the room-temperature resistivity of each specimen.

Referring to FIG. 9, it can be seen that when the addition amount of SiO₂ is increased while maintaining the mixing ratio of barium titanate with KNN at a constant value, the absolute value of specific inductive capacity is reduced. However, in this case, it can be also seen that the specific inductive capacity inductive capacity is maintained constantly against frequency with no significant variation and the dielectric loss value is maintained with a variation of about 1% or less.

Therefore, it can be seen that the specific inductive capacity shows a variation ranging from 0 to 20, except the characteristics of the dielectric having a mixing ratio of 95BaTiO₃-5KNN, and the dielectric loss is maintained with a variation of about 1% or less. As the ratio of KNN mixed with barium titanate is increased gradually, the dielectric constant tends to be decreased.

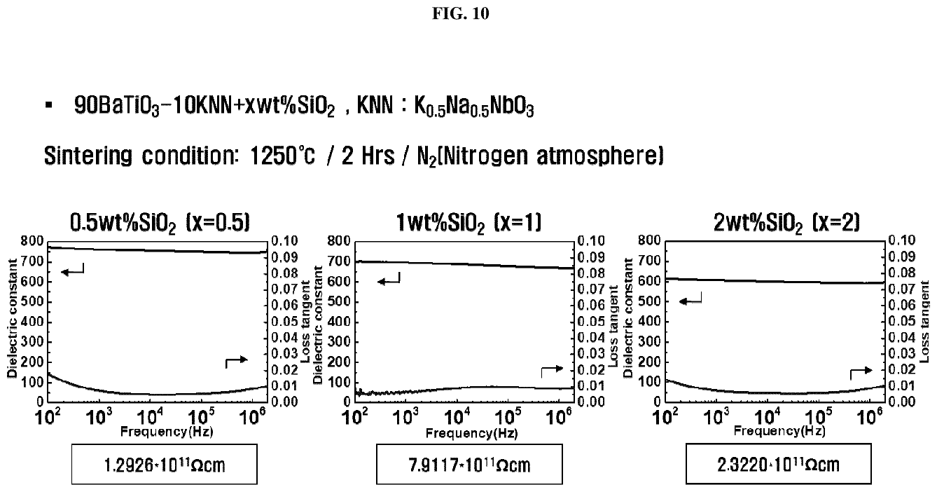

FIG. 10 is a graph illustrating variations in specific inductive capacity and dielectric loss values depending on SiO₂ content in 90BaTiO₃-10KNN according to an embodiment of the present disclosure, wherein the values below the graphs are tables representing the room-temperature resistivity of each specimen.

Referring to FIG. 10, it can be seen that when the addition amount of SiO₂ is increased while maintaining the mixing ratio of barium titanate with KNN at a constant value, the absolute value of specific inductive capacity is reduced. However, in this case, it can be also seen that the specific inductive capacity inductive capacity is maintained constantly against frequency with no significant variation and the dielectric loss value is maintained with a variation of about 1% or less.

The following Table 4 shows the dielectric characteristics and room-temperature resistivity of specimens having different mixing ratios of ABO₃ oxide or SiO₂ in combination with the data of samples illustrated in FIGS. 9 and 10.

TABLE 4

| | | | Additive | | | | | |
|---|---|---|---|---|---|---|---|---|
| | | | based on | | | | | Room- |
| | (100-x)BaTiO₃-xKNN | | BaTiO₃ | Dielectric characteristics | | | | temperature |
| | BaTiO₃ | KNN | SiO₂ | ∈ᵣ | | tan δ(%) | | resistivity |
| | (100-x) | (x) | (wt %) | 1 kHz | 2 MHz | 1 kHz | 2 MHz | (ohm-cm) |
| Ex. 1-1 | 95 | 5 | 0.5 | 4029.53 | 1924.66 | 7.65 | 12.1 | Overcurrent |
| Ex. 1-2 | 95 | 5 | 1 | 1424.21 | 1325.40 | 2.12 | 1.87 | 1.7343*10¹² |
| Ex. 1-3 | 95 | 5 | 2 | 3961.00 | 2174.15 | 32.4 | 9.11 | Overcurrent |
| Ex. 1-4 | 90 | 10 | 0.5 | 761.96 | 750.69 | 0.75 | 1.03 | 1.2926*10¹¹ |
| Ex. 1-5 | 90 | 10 | 1 | 697.59 | 674.36 | 0.68 | 0.89 | 7.9117*10¹¹ |
| Ex. 1-6 | 90 | 10 | 2 | 606.26 | 597.45 | 0.75 | 1.07 | 2.3220*10¹¹ |
| Ex. 1-7 | 85 | 15 | 0.5 | 675.48 | 670.89 | 0.49 | 0.90 | 5.0831*10¹⁰ |
| Ex. 1-8 | 85 | 15 | 1 | 514.22 | 510.10 | 0.50 | 0.91 | 1.2926*10¹¹ |
| Ex. 1-9 | 85 | 15 | 2 | 470.45 | 468.05 | 0.41 | 0.84 | 3.1908*10¹¹ |

### Analysis of Dielectric Characteristics and Room-Temperature Resistivity of Example 2

Both surfaces of disc-shaped pellets obtained by the method according to Example 2 were polished and Ag paste was applied to both surfaces of a specimen through a silk-screening process. Then, the dielectric constant and dielectric loss were determined by using an LCR meter, and dielectric resistance was determined in the same manner as Example 1.

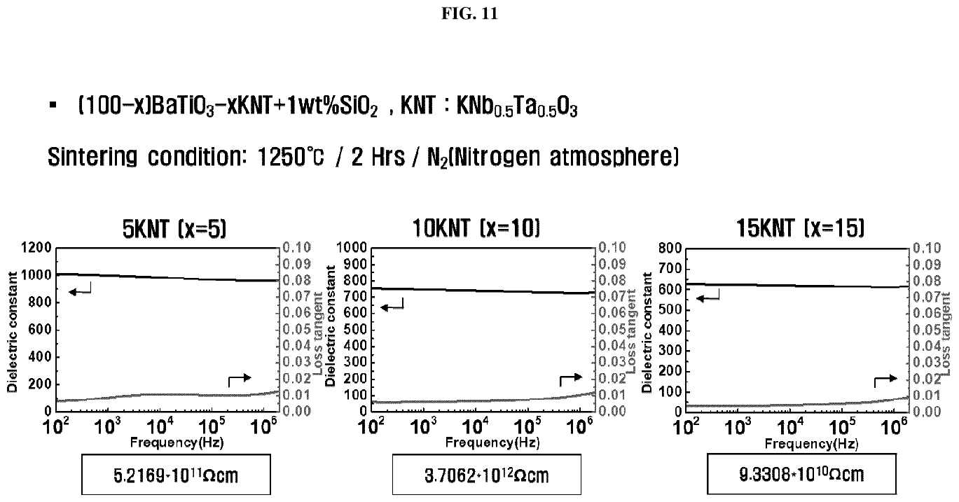

The results are shown in FIG. 11. FIG. 11 is a graph illustrating variations in specific inductive capacity and dielectric loss values depending on frequency, determined as a function of concentration of x in the specimen of (100−x)BaTiO₃−xKNT+1 wt % SiO₂ according to an embodiment of the present disclosure, wherein the values below the graphs are tables representing the room-temperature resistivity of each specimen.

Referring to FIG. 11, it can be seen that the specific inductive capacity and dielectric loss values are maintained constantly with no significant variation in the frequency range applied to the test. It can be also seen that the specific inductive capacity shows a variation ranging from 0 to 30 and the dielectric loss is maintained with a variation of about 1% or less. In addition, as the ratio of KNT mixed with barium titanate is increased gradually, the dielectric constant tends to be decreased.

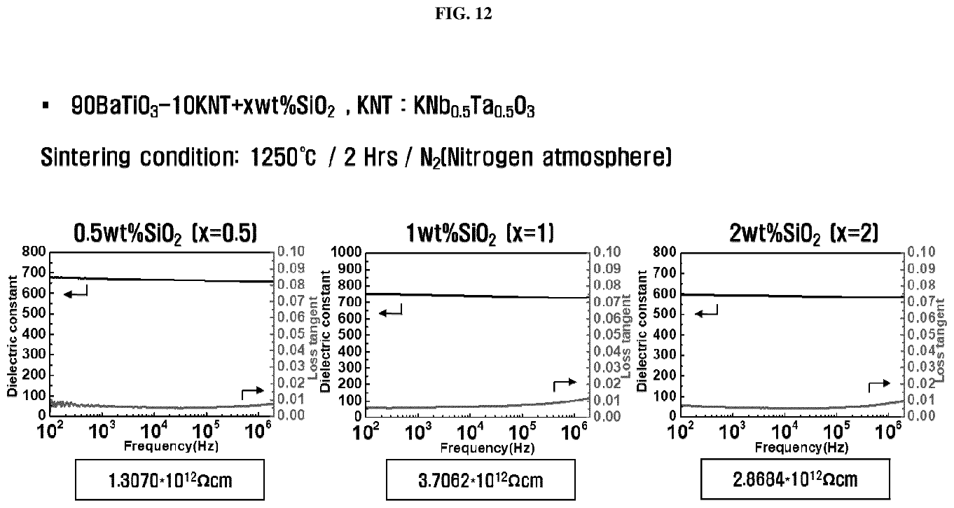

Further, FIG. 12 is a graph illustrating variations in specific inductive capacity and dielectric loss values depending on SiO₂ content in 90BaTiO₃-10KNT according to an embodiment of the present disclosure, wherein the values below the graphs are tables representing the room-temperature resistivity of each specimen.

Referring to FIG. 12, it can be seen that when the addition amount of SiO₂ is increased while maintaining the mixing ratio of barium titanate with KNT at a constant value, the absolute value of specific inductive capacity is reduced. However, in this case, it can be also seen that the specific inductive capacity inductive capacity is maintained constantly against frequency with no significant variation and the dielectric loss value is maintained with a variation of about 1% or less.

The following Table 5 shows the dielectric characteristics and room-temperature resistivity of specimens having different mixing ratios of ABO₃ oxide or SiO₂ in combination with the data of samples illustrated in FIGS. 11 and 12.

TABLE 5

| | | | Additive | | | | | |
|---|---|---|---|---|---|---|---|---|
| | | | based on | | | | | Room- |
| | (100-x)BaTiO₃-xKNT | | BaTiO₃ | Dielectric characteristics | | | | temperature |
| | BaTiO₃ | KNT | SiO₂ | ∈ᵣ | | tan δ(%) | | resistivity |
| | (100-x) | (x) | (wt %) | 1 kHz | 2 MHz | 1 kHz | 2 MHz | (ohm-cm) |
| Ex. 2-1 | 95 | 5 | 0.5 | 1111.38 | 1077.53 | 1.08 | 1.23 | 3.4289*10¹¹ |
| Ex. 2-2 | 95 | 5 | 1 | 999.96 | 969.21 | 0.87 | 1.26 | 5.2169*10¹¹ |
| Ex. 2-3 | 95 | 5 | 2 | 937.17 | 903.71 | 0.99 | 1.43 | 3.4689*10¹² |
| Ex. 2-4 | 90 | 10 | 0.5 | 672.72 | 659.26 | 0.63 | 0.75 | 1.3070*10¹² |
| Ex. 2-5 | 90 | 10 | 1 | 744.67 | 731.12 | 0.61 | 1.18 | 3.7062*10¹¹ |
| Ex. 2-6 | 90 | 10 | 2 | 592.74 | 587.09 | 0.59 | 0.99 | 2.8684*10¹¹ |
| Ex. 2-7 | 85 | 15 | 0.5 | 571.73 | 566.15 | 0.68 | 0.96 | 2.8469*10¹⁰ |
| Ex. 2-8 | 85 | 15 | 1 | 513.22 | 510.10 | 0.53 | 0.91 | 9.3308*10¹⁰ |
| Ex. 2-9 | 85 | 15 | 2 | 397.26 | 391.76 | 0.49 | 0.50 | 3.7229*10¹¹ |

### Analysis of Dielectric Characteristics and Room-Temperature Resistivity of Example 3

Both surfaces of disc-shaped pellets obtained by the method according to Example 3 were polished and Ag paste was applied to both surfaces of a specimen through a silk-screening process. Then, the dielectric constant and dielectric loss were determined by using an LCR meter, and dielectric resistance was determined in the same manner as Example 1.

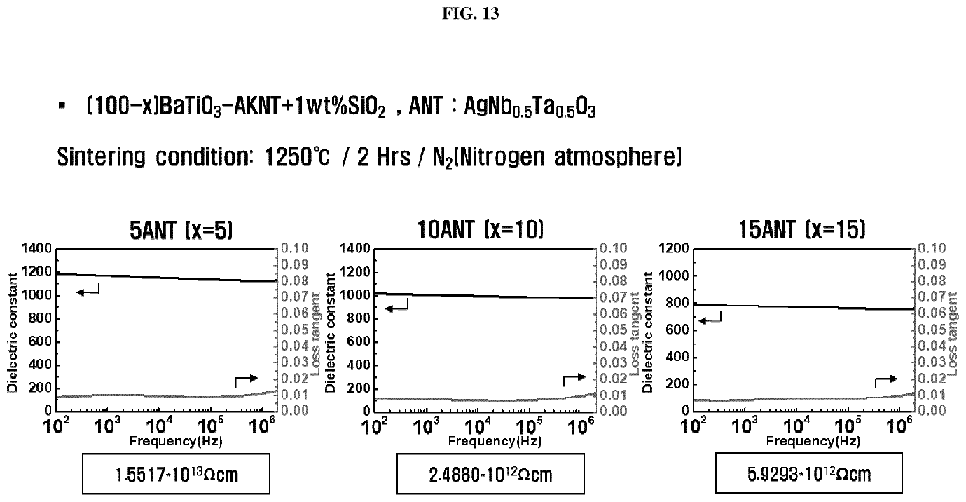

The results are shown in FIG. 13.

FIG. 13 is a graph illustrating variations in specific inductive capacity and dielectric loss values depending on frequency, determined as a function of concentration of x in the specimen of (100−x)BaTiO₃-xANT+1 wt % SiO₂ according to an embodiment of the present disclosure, wherein the values below the graphs are tables representing the room-temperature resistivity of each specimen.

Referring to FIG. 13, it can be seen that the specific inductive capacity and dielectric loss values are maintained constantly with no significant variation in the frequency range applied to the test. It can be also seen that the specific inductive capacity shows a variation ranging from 0 to 25 and the dielectric loss is maintained with a variation of about 1% or less. In addition, as the ratio of ANT mixed with barium titanate is increased gradually, the dielectric constant tends to be decreased.

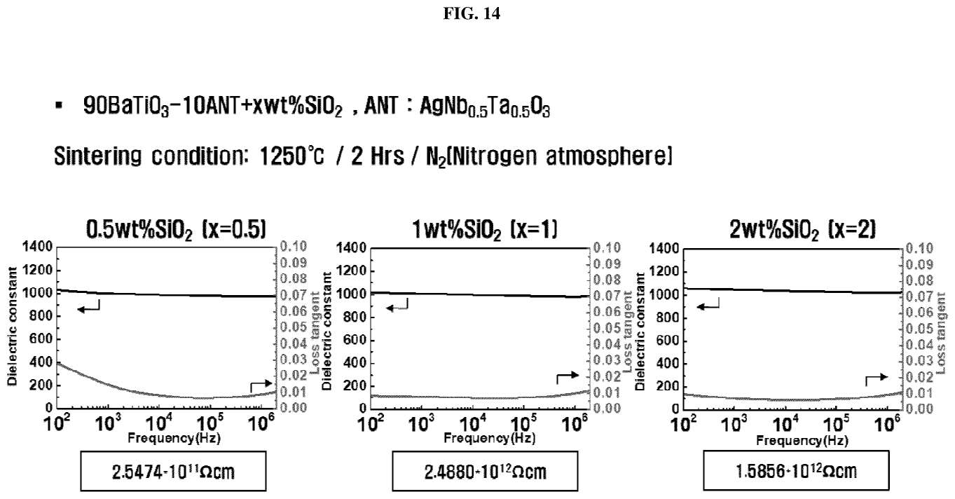

Further, FIG. 14 is a graph illustrating variations in specific inductive capacity and dielectric loss values depending on SiO₂ content in 90BaTiO₃-10ANT according to an embodiment of the present disclosure, wherein the values below the graphs are tables representing the room-temperature resistivity of each specimen

Referring to FIG. 14, it can be seen that when the addition amount of SiO₂ is increased while maintaining the mixing ratio of barium titanate with ANT at a constant value, the absolute value of specific inductive capacity is reduced. However, in this case, it can be also seen that the specific inductive capacity inductive capacity is maintained constantly against frequency with no significant variation and the dielectric loss value is maintained with a variation of about 1% or less.

The following Table 6 shows the dielectric characteristics and room-temperature resistivity of specimens having different mixing ratios of ABO₃ oxide or SiO₂ in combination with the data of samples illustrated in FIGS. 13 and 14.

TABLE 6

| | | | Additive | | | | | |
|---|---|---|---|---|---|---|---|---|
| | | | based on | | | | | Room- |
| | (100-x)BaTiO₃-xANT | | BaTiO₃ | Dielectric characteristics | | | | temperature |
| | BaTiO₃ | ANT | SiO₂ | ∈ᵣ | | tan δ(%) | | resistivity |
| | (100-x) | (x) | (wt %) | 1 kHz | 2 MHz | 1 kHz | 2 MHz | (ohm-cm) |
| Ex. 3-1 | 95 | 5 | 0.5 | 1177.63 | 1156.44 | 0.66 | 1.22 | 1.2207*10¹¹ |
| Ex. 3-2 | 95 | 5 | 1 | 1169.98 | 1132.23 | 1.02 | 1.30 | 1.5517*10¹¹ |
| Ex. 3-3 | 95 | 5 | 2 | 960.62 | 933.51 | 0.93 | 1.24 | 2.0181*10¹¹ |
| Ex. 3-4 | 90 | 10 | 0.5 | 1000.34 | 977.86 | 1.48 | 1.06 | 2.5474*10¹¹ |
| Ex. 3-5 | 90 | 10 | 1 | 1007.41 | 986.78 | 0.78 | 1.12 | 2.4880*10¹¹ |
| Ex. 3-6 | 90 | 10 | 2 | 1046.87 | 1026.43 | 0.72 | 1.11 | 1.5856*10¹¹ |
| Ex. 3-7 | 85 | 15 | 0.5 | 814.68 | 800.27 | 0.87 | 1.03 | 2.7174*10¹¹ |
| Ex. 3-8 | 85 | 15 | 1 | 787.23 | 764.23 | 0.69 | 1.12 | 3.7229*10¹¹ |
| Ex. 3-9 | 85 | 15 | 2 | 640.28 | 630.63 | 0.66 | 0.97 | 1.2117*10¹¹ |

It can be seen that when the type of ABO₃ oxide mixed with barium titanate is ANT as described above, it is possible to realize a high value of room-temperature resistivity corresponding to a level of 10¹³ ohm-cm.

### Test Example 3. Determination of Variations in Specific Inductive Capacity and Dielectric Loss Values Depending on Temperature of Fired Specimens of ABO₃ Oxide

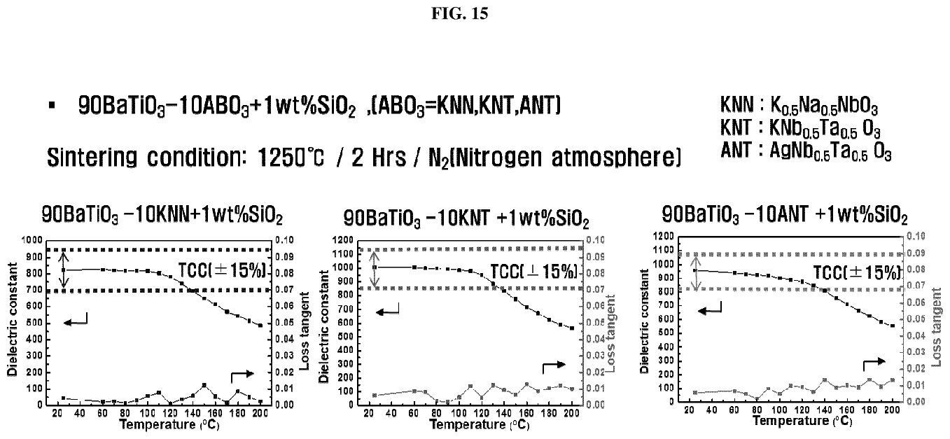

Fired specimens of ABO₃ oxide were determined for variations in specific inductive capacity and dielectric loss values. The results are shown in FIG. 15.

FIG. 15 is a graph illustrating variations in specific inductive capacity and dielectric loss values as a function of temperature depending on ABO₃ oxide type in 90BaTiO₃-10ABO₃+1 wt % SiO₂ according to an embodiment of the present disclosure.

Referring to FIG. 15, in the case of a sample using KNN as ABO₃ oxide, it can be seen that TCC±15% is accomplished to 140° C. based on the room-temperature resistivity. Also, in the case of KNT and ANT, it can be seen that TCC±15% is accomplished to 135° C. based on the room-temperature resistivity.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method for preparing a dielectric, comprising the steps of:
preparing ABO₃ oxide having a melting point lower than the firing temperature of barium titanate (BaTiO₃);
mixing barium titanate with ABO₃ oxide to obtain a mixture satisfying the following Formula 1; and
sintering the mixture at a temperature equal to or higher than the melting point of ABO₃ oxide,
wherein the ABO₃ oxide is introduced to and distributed in the grain boundary of barium titanate in the sintering step:
(1−x) BaTiO₃-xABO₃ [Formula 1]
wherein x is 0.01-0.30.

2. The method for preparing a dielectric of claim 1, wherein the mixture satisfies the following Formula 2:
(1−x)BaTiO₃—xAₐB_{b}O₃ [Formula 2]
wherein A is at least one selected from the group consisting of lithium (Li), potassium (K), sodium (Na) and silver (Ag),
B is at least one selected from the group consisting of vanadium (V), niobium (Nb) and tantalum (Ta),
x is 0.05-0.15,
a is 0.1-1, and
b is 0.1-1.

3. The method for preparing a dielectric of claim 1, wherein the ABO₃ oxide is at least one selected from the group consisting of K_{0.5}Na_{0.5}NbO₃, KNb_{0.5}Ta_{0.5}O₃ and AgNb_{0.5}TaO_{0.5}O₃.

4. The method for preparing a dielectric of claim 1, wherein the step of preparing a mixture further comprises a step of adding SiO₂ to the mixture of barium titanate with ABO₃ oxide.

5. The method for preparing a dielectric of claim 4, wherein the content of SiO₂ added to the mixture is 20 wt % or less based on the weight of barium titanate.

6. The method for preparing a dielectric of claim 1, wherein the sintering step is carried out at a temperature of 900-1300° C.

7. A dielectric which comprises barium titanate (BaTiO₃) and ABO₃ oxide to satisfy the following Formula 1, wherein the ABO₃ oxide is distributed in the grain boundary of barium titanate:
(1−x)BaTiO₃—xABO₃ [Formula 1]
wherein x is 0.01-0.30.

8. The dielectric of claim 7, wherein barium titanate (BaTiO₃) and ABO₃ oxide in the dielectric satisfies the following Formula 2:
(1−x)BaTiO₃—xAₐB_{b}O₃ [Formula 2]
wherein A is at least one selected from the group consisting of lithium (Li), potassium (K), sodium (Na) and silver (Ag),
B is at least one selected from the group consisting of vanadium (V), niobium (Nb) and tantalum (Ta),
x is 0.05-0.15,
a is 0.1-1, and
b is 0.1-1.

9. The dielectric of claim 7, wherein the ABO₃ oxide is at least one selected from the group consisting of K_{0.5}Na_{0.5}NbO₃, KNb_{0.5}Ta_{0.5}O₃ and AgNb_{0.5}Ta_{0.5}O₃.

10. The dielectric of claim 7, which maintains a dielectric loss value of 0-3% and shows a variation in specific inductive capacity of 20% or less.

11. The dielectric of claim 7, wherein ABO₃ oxide is K_{0.5}Na_{0.5}NbO₃, and the dielectric has a specific inductive capacity of 500-1400 in a frequency region of 1 MHz or more.

12. The dielectric of claim 7, wherein ABO₃ oxide is KNb_{0.5}Ta_{0.5}O₃, and the dielectric has a specific inductive capacity of 400-1100 in a frequency region of 1 MHz or more.

13. The dielectric of claim 7, wherein ABO₃ oxide is AgNb_{0.5}Ta_{0.5}O₃, and the dielectric has a specific inductive capacity of 600-1200 in a frequency region of 1 MHz or more.
